(19) United States
(12) Patent Application Publication
(10) Pub. No.: US 2004/0232607 A1
(43) Pub. Date: Nov. 25, 2004

(54) Vibration-damping link and a method of manufacturing said link

(76) Inventors: Laurent Bodin, Espieds en Beauce (FR); Arnaud Lede, Chateaudun (FR)

Correspondence Address: Julian F. Santos, McDonnell Boehnen Hulbert & Berghoff, 32nd Floor, 300 S. Wacker Drive, Chicago, IL, 60606, US

(21) Appl. No.: 10/789,683

(22) Filed: Feb. 27, 2004

(30) Foreign Application Priority Data
Feb. 27, 2003 (FR) 03 02393

(51) Int. Cl. F16M 5/00

(52) U.S. Cl. 267/140.12; 267/141.2

(57) ABSTRACT

A vibration-damping link including a flex fitted into an end sleeve. Resistance to a force tending to disengage the flex from the sleeve is increased by performing punching around the flex.

### FIELD

The present invention relates to vibration-damping links, and more particularly, a vibration-link used for taking up torque from engine-and-gearbox units in motor vehicles.

### BACKGROUND

Known vibration-damping links have an element that can be referred to as a “flex.” In at least one of the known vibration-damping links, the flex may be constructed from a combination of (i) a ring that is typically constructed from plastic material, (ii) a flexible coupling that is typically constructed from an elastomer material, and (iii) an inner strength member that is typically constructed from a metal or metallic material. The flex, in turn, is tightly fitted into a sleeve of a metal body of the vibration-damping link.

Unfortunately, when using this type of construction, the flex may disengage from the sleeve as resistance to applied forces increases above a threshold force. To combat this problem and increase the resistance to applied force, the body of the legacy vibration-damping link may be formed or otherwise constructed using known relief and/or strengthening mechanisms.

This solution, however, is not always desirable or possible. For example, attaining an optimized geometrical shape to meet the force requirements may require certain angles, e.g., compound angles, and roughness, e.g., gnarled surfaces, that are theoretically possible, but practically impossible to manufacture. Moreover, even if an optimized geometrical shape may be formed using manual and/or automated machining tools and/or casting tools, the cost to manufacture such a vibration-damping link may be prohibitive. For example, when the body is constructed using an extrusion process, the surfaces of the body formed by an extrusion die are smooth. Thus, the body may have to undergo a costly machining process to obtain the desired roughness.

Therefore what is needed is a vibration-damping link that are inexpensive, easy to manufacture, and offer higher resistance to a force tending to disengage the flex from its sleeve.

### SUMMARY

In one aspect of the present invention, a vibration-damping link is provided. The vibration-damping link may include a metal body that is elongate in a longitudinal direction and that interconnects a first end sleeve and a second end sleeve. Both of the first end and the second end sleeves may be part of the body, said may be provided with respective first and second passageways that extend through the body along respective first and second axes. At least one inner strength member may be surrounded by a first sleeve and mounted to move inside the first passageway. At least one ring may surround the inner strength member and may be adapted to be inserted into and held in the first passageway. The ring also extends along an axis.

At least one flexible coupling made of elastomer maybe interposed between the inner strength member and the ring. At least the first sleeve is provided with (i) at least a first edge that surrounds the first passageway, and (ii) at least one deformed zone that is deformed by punching the metal body so as to form a protuberance co-operating with the ring.

By means of this protuberance, the interaction between the flex and the sleeve into which it is inserted is increased. Resistance to a disengagement force is increased. The punching operation is inexpensive and simple to implement.

In other aspects of the invention, it is optionally possible also to use one or more of the following provisions. Firstly, the link may be provided with a second edge that surrounds the first passageway, and at least one deformed zone that is deformed by punching the metal body. The combination of these may form a protuberance co-operating with the ring, and the first and second edges surrounding the axial orifices of the first passageway. That is, the link is punched on both of its faces.

Secondly, the link may be provided with a plurality of deformed zones that are (i) deformed by punching the metal body, and (ii) distributed around the first passageway. Thirdly, the link may be provided with a deformed zone that (i) is deformed by punching the metal body, and (ii) surrounds the passageway continuously. Fourthly, at least one of the deformed zones that are deformed by punching the metal body exerts a stress on the ring so as to deform the ring towards the first axis. Fifthly, the ring may be made of a plastic material.

In yet another aspect of the invention, a method of manufacturing a vibration-damping link noted above is provided. The method may include the steps of (i) fitting the assembly constituted by the ring, by the flexible coupling and by the inner strength member into the first passageway while causing the axes in which the first passageway and the ring extend to coincide, and (ii) deforming by punching at least one zone of the first edge of the first sleeve, so as to form a protuberance co-operating with the ring.

In implementing the method, it is optionally possible to use one or more of the following provisions. Firstly, a plurality of sectors of the first edge of the first sleeve may be deformed. Secondly; the first edge of the first sleeve may be deformed circularly and continuously around the first passageway. Thirdly, the first edge and a second edge that surrounds respective ones of the axial orifices of the first passageway may be formed by punching.

### BRIEF DESCRIPTION OF THE DRAWINGS

Preferred embodiments of the present invention are described with reference to the following drawings wherein like reference numerals refer to like elements in the various figures, and wherein:

FIG. 1 is a perspective view of a link of the present invention, before it is deformed by punching;

FIG. 2 is a longitudinal view on the plane II-II of one of the sleeves of the link shown in FIG. 1;

FIG. 3 is a section view analogous to the view of FIG. 2 and showing the sleeve of FIG. 2 after punching;

FIG. 4 is a diagrammatic plan view of a link sleeve of the invention in a first embodiment;

FIG. 5 is a view analogous to the view of FIG. 4 and showing a second embodiment of the link of the invention; and

FIG. 6 is a section view analogous to the views of FIGS. 2 and 3 and showing a variant of the first and second embodiments of the link of the invention.

### DETAILED DESCRIPTION OF PRESENTLY PREFERRED EMBODIMENTS

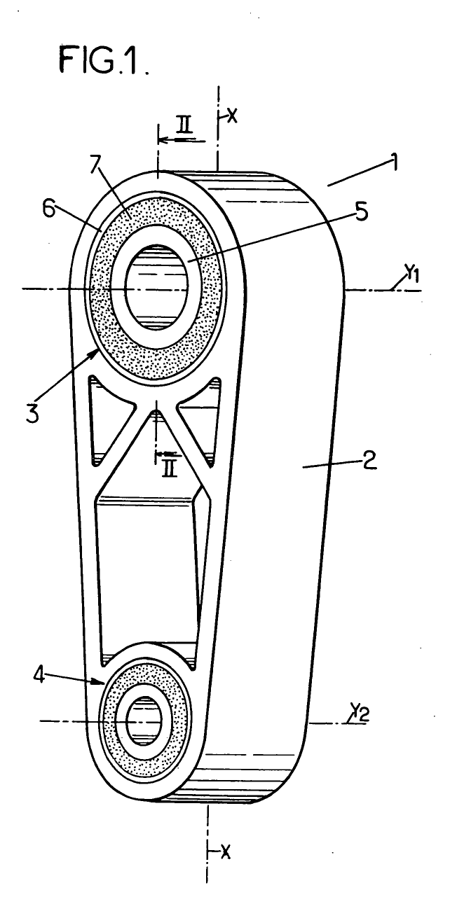

As shown in FIG. 1, a link 1 manufactured in accordance with the method of the invention comprises a metal elongate body 2 which may extend in a longitudinal direction X, and which may interconnect first and second sleeves 3, 4. The first and second sleeves 3, 4 may be centered on respective ones of first and second axes Y1 and Y2 that are perpendicular to the longitudinal direction X.

The body 2 may be made of a ductile material, such as aluminum, using an extrusion process and die, for instance. For simplification reasons, only the first sleeve 3 is described in detail below. The structure of the link 1 at the second sleeve 4 can be easily deduced by the person skilled in the art from the following description of the link 1 at the first sleeve 3.

The first sleeve 3 may surround an inner strength member 5. The inner strength member 5 may made of metal, and like, the first sleeve 3 may be formed in a tubular shape centered on the first axis Y1. At the first sleeve 3, the link 1 may further include a ring 6. The ring 6 may be made of a plastic material. The ring 6 may be formed in a tubular shape that can be centered on the first axis Y1.

The inner strength member 5 may be connected to the ring 6 via a flexible coupling 7. The flexible coupling 7, for example, may be formed into a body made of elastomer that can adhere to and be overmolded on the inner strength member 5 and the ring 6.

The strength member 5, the ring 6, and the flexible coupling 7 may form a flex serving to be fitted into the first sleeve 3. The flexible coupling 7 makes it possible to damp relative movement between the strength member 5 and the body 2.

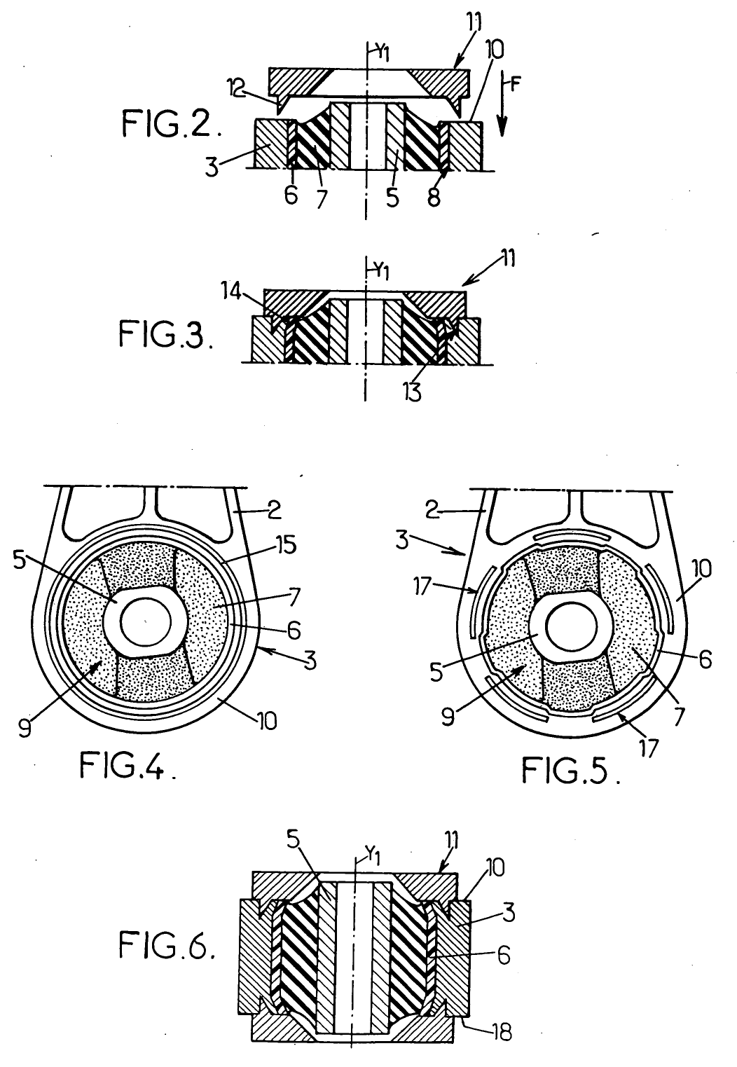

As shown in FIG. 2, the first sleeve 3 forms a cylindrical wall that is circularly symmetrical about the first axis Y1. The inside surface 8 of the cylindrical wall may define a passageway 9 into which the ring 6 may be tightly fitted. The passageway 9 may be surrounded by a first edge 10, which, in this example, extends in a plane perpendicular to the first axis Y1.

In the method of the invention, a punching tool 11 is moved along the first axis Y1 towards the first edge 10 (see arrow F). The punching tool 11 may include a punch 12 with one face 13 facing so as to act in the vicinity of the punch 12 to displace the material towards the ring 6, i.e., towards the first axis Y1.

As shown in FIG. 3, during its movement in the direction of shown by arrow F, the punching tool 11 may punch the first sleeve 3 so that the material displaced by the punch 12 exerts stress on the ring 6. This stress may deform the ring 6 towards the first axis Y1. The force of interaction between the first sleeve 3 and the ring 6 is thus increased, which in turn, increases the resistance of the force that tends to disengage the flex from the first sleeve 3. The zone of the first sleeve that is deformed by the punch 12 may form a protuberance or a bead 14 that interacts with the ring 6.

FIG. 4 shows another embodiment of the link 1. In this embodiment, at least the first edge 10 is provided with a continuous deformation 15 extending all the way around the passageway 9. The continuous deformation 15 may be formed using a punch and/or punching operation.

FIG. 5 shows yet another embodiment of the link 1. In this embodiment, at least a first edge 10 is provided with five zones angularly distributed uniformly about the first axis Y1. Like the continuous deformation 15, the first edge 10 may be formed using a punch and/or punching operation.

As shown in FIG. 6, the above-described punching operation can be performed on the first edge 10, and also on a second edge 18, which edges surround respective ones of the axial orifices of the first passageway 9.

### CONCLUSION

In the foregoing detailed description, numerous specific details are set forth in order to provide a thorough understanding of exemplary embodiments described herein. However, it will be understood that these embodiments may be practiced without the specific details. In other instances, well-known methods, procedures, components and circuits have not been described in detail, so as not to obscure the following description.

Further, the embodiments disclosed are for exemplary purposes only and other embodiments may be employed in lieu of or in combination with of the embodiments disclosed. For example, the first and second axes Y1 and Y2 are not necessarily mutually parallel or perpendicular to the longitudinal direction X. Similarly, the first sleeve 3 and/or the ring 6 may not necessarily of tubular shape or centered on the first axis Y1, and their geometrical shapes may be different and not centered on the first axis Y1. In addition, the first edge 10 may not necessarily be in a plane that is perpendicular to the first axis Y1, or have punched zones that are necessarily uniformly angularly distributed about the first axis Y1. Additionally, the number of punched zones of the first edge 10 may be less than or greater than five (e.g., the number lies in the range 1 to n, where n is not limited).

Exemplary embodiments have been illustrated and described. Further, the claims should not be read as limited to the described order or elements unless stated to that effect.

What is claimed is:

1. A vibration-damping link comprising:
a metal body that is elongate in a longitudinal direction and that interconnects a first end sleeve and a second end sleeve, both of which are part of the body, said first and second sleeves being provided with respective ones of first and second passageways that extend through the body along respective ones of first and second axes;
at least one inner strength member surrounded by a first sleeve and mounted to move inside the first passageway;
at least one ring surrounding the inner strength member and adapted to be inserted into and to be held in the first passageway, said ring also extending along an axis; and
at least one flexible coupling made of elastomer, interposed between the inner strength member and the ring, wherein at least the first sleeve is provided with at least a first edge surrounding the first passageway and provided with at least one deformed zone that is deformed by punching the metal body, so as to form a protuberance co-operating with the ring.

2. A vibration-damping link according to claim 1, provided with a second edge surrounding the first passageway and provided with at least one deformed zone that is deformed by punching the metal body, so as to form a protuberance co-operating with the ring, the first and second edges surrounding the axial orifices of the first passageway (9).

3. A vibration-damping link according to claim 1, provided with a plurality of deformed zones that are deformed by punching the metal body and that are distributed around the first passageway.

4. A vibration-damping link according to claim 1, provided with a deformed zone that is deformed by punching the metal body and that surrounds the passageway continuously.

5. A vibration-damping link according to claim 1, in which at least one of the deformed zones that is deformed by punching the metal body exerts stress on the ring that is adapted to deform said ring towards the first axis.

6. A vibration-damping link according to claim 1, in which the ring is made of a plastics material.

7. A method of manufacturing a vibration-damping link according to claim 1, comprising steps consisting in:
fifting the assembly constituted by the ring, by the flexible coupling and by the inner strength member into the first passageway while causing the axes in which the first passageway and the ring extend to coincide; and in
deforming by punching at least one zone of the first edge of the first sleeve, so as to form a protuberance co-operating with the ring.

8. A manufacturing method according to claim 7, in which a plurality of sectors of the first edge of the first sleeve are deformed.

9. A manufacturing method according to claim 7, in which the first edge of the first sleeve is deformed circularly and continuously around the first passageway.

10. A manufacturing method according to claim 7, in which the first edge and a second edge that surround respective ones of the axial orifices of the first passageway are punched.

11. A vibration-damping link according to claim 2, provided with a deformed zone that is deformed by punching the metal body and that surrounds the passageway continuously.

12. A manufacturing method according to claim 8, in which the first edge and a second edge that surround respective ones of the axial orifices of the first passageway are punched.

13. A manufacturing method according to claim 9, in which the first edge and a second edge that surround respective ones of the axial orifices of the first passageway are punched.
